(19) United States
(12) Patent Application Publication
(10) Pub. No.: US 2021/0048795 A1
(43) Pub. Date: Feb. 18, 2021

(54) SYSTEM AND METHOD FOR ACCESSING AND USING INTERNAL RESOURCES OF A MOBILE DEVICE USED IN CONNECTION WITH AND AS A PART OF AN INDUSTRIAL DEVICE OR AS A DEVELOPMENT TOOL

(71) Applicant: Paolo Ginobbi, Las Vegas, NV (US)

(72) Inventor: Paolo Ginobbi, Las Vegas, NV (US)

(21) Appl. No.: 16/994,390

(22) Filed: Aug. 14, 2020

Related U.S. Application Data
(60) Provisional application No. 62/922,549, filed on Aug. 15, 2019.

(51) Int. Cl. G05B 19/4155; G06F 13/42; G06F 11/30; G06F 11/34

(52) U.S. Cl. CPC G05B 19/4155; G06F 13/4282; G05B 2219/31449; G06F 11/3495; G06F 2213/0042; G06F 11/3013

(57) ABSTRACT

A system and a method for accessing and using internal resources of a mobile device, such as a smartphone or a tablet computing device, used in connection with and as a part of an industrial device or as a development tool is disclosed.

### CLAIM OF BENEFIT TO PRIOR APPLICATION

This application claims benefit to U.S. Provisional Patent Application 62/922,549, entitled “Ginobbi concept,” filed Aug. 15, 2019. The U.S. Provisional Patent Application 62/922,549 is incorporated herein by reference.

### BACKGROUND

Embodiments of the invention described in this specification relate generally to industrial application resource processing and development tools, and more particularly, to a system and a method for accessing and using internal resources of a mobile device, such as a smartphone or a tablet computing device, used in connection with and as a part of an industrial device or as a development tool.

Many industrial machines and devices include applications that operate aspects of the machines or monitor things outside of the machines, etc. However, many times a user would like to be able to control or evaluate operation of the industrial machines when not actually present in or around the area. This is a problem especially in contaminated areas or other areas in which knowledgeable human workers are not able to be present.

Additionally, many aspiring engineers and developers would like to understand ways to interact with, monitor, or otherwise operate said industrial machines via such applications, but may lack sufficient knowledge to do so.

Therefore, what is needed is a way to allow designers, students, and/or hobbyists to access and use Internet of Things connectivity for their projects without specific knowledge as a development tool and for operators, controllers, or other administrative personnel to use a mobile device, such as a smartphone, as a hardware device with internal components that can be leveraged in the operation, monitoring, or control of industrial machines.

### BRIEF DESCRIPTION

A novel system and method for accessing and using internal resources of a mobile device used in connection with and as a part of an industrial device is disclosed. In some embodiments, the system and the method for accessing and using internal resources of a mobile device used in connection with and as a part of an industrial device simplifies, and reduces the cost of, producing and operating various equipment, including multiple units in an Internet of Things (“IoT”) ecosystem, by providing needed functions through computer applications via a mobile computing device. In some embodiments, the system and the method for accessing and using internal resources of a mobile device used in connection with and as a part of an industrial device includes a monitor program for use within an electronic and/or mechanical unit (hereinafter referred to as an “operating unit” or simply as a “unit”) of a productive environment.

In some embodiments, the system makes internal resources of a mobile device available outside the mobile device for one or more operating units of any of several industrial applications by using the mobile device's built-in communication hardware. In some embodiments, the method for accessing and using the internal resources of the mobile device is implemented as a monitor program that runs on the mobile device, thereby enabling access to the internal resources of the mobile device. The monitor program (hereinafter also referred to as the “Monitor” or “monitor”, or variously referred to as the “monitor program”, “monitor application”, or “monitor app” running on the mobile device) is an operationally central and fundamental aspect of the system. The internal resources may vary from one mobile device to another mobile device. Examples of internal resources of the mobile device include, without limitation, an embedded/onboard camera of the mobile device, a keypad (which at a kernel layer receives alpha-numeric and symbolic inputs of a keyboard, whether a software-based keyboard displayed on a touchscreen or hardware-based keyboard), GPS, accelerometer, memory, display, etc. The mobile device may be a cell phone, such as a smartphone, a tablet computing device, a personal digital assistant (PDA), such as an iPod™ (by Apple Inc.), etc. Examples of communication hardware include, without limitation, Bluetooth, GSM, Wi-Fi, serial COM port, etc.

In some embodiments, the system is used (by a user) as a development tool to facilitate the use and the comprehension of the features provided through the system. In some embodiments, the system is deployed as a development tool by way of a circuit board (hereinafter also referred to as an “IOTKIT”). In some embodiments, the IOTKIT includes an interface to communicate via Bluetooth, another interface to communicate with a COM port, and a microprocessor to allow the user to develop test programs. In some embodiments, the combination of the mobile device and the IOTKIT form the development tool.

In some embodiments, the system is encapsulated into a device in an integration of an IOTKIT and its features directly into a mobile device or other type of computing device. In some embodiments, the integration is accomplished by way of a hybrid IoT device chip (hereinafter also referred to as an “IOT CHIP”) that can be mounted inside a circuit board like any other component.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a block diagram of a system that accesses and uses internal resources of a smartphone in connection with an industrial device in some embodiments.

FIG. 2 conceptually illustrates a schematic diagram of a system that accesses and uses internal resources of a smartphone in connection with an industrial device in some embodiments.

FIG. 3 conceptually illustrates an elevation view of the system, during use, while accessing and using internal resources of a smartphone in connection with an industrial device in some embodiments.

FIG. 4 conceptually illustrates an example of a user interface of a smartphone used for its internal resources in connection with an industrial device.

FIG. 5 conceptually illustrates an elevation view of the system controlling operation of an industrial device by accessing and using the internal resources of a connected smartphone in some embodiments.

FIG. 6 conceptually illustrates an elevation view of the system recording a video with a connected smartphone during operation of an industrial device that is controlled by accessing and using the internal resources of the smartphone in some embodiments.

FIG. 7 conceptually illustrates conceptually illustrates a block diagram of a mobile device with internal resources used by the system in some embodiments.

FIG. 8 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel system and method for accessing and using internal resources of a mobile device used in connection with and as a part of an industrial device. In some embodiments, the system and the method for accessing and using internal resources of a mobile device used in connection with and as a part of an industrial device simplifies, and reduces the cost of, producing and operating various equipment, including multiple units in an Internet of Things (“IoT”) ecosystem, by providing needed functions through computer applications via a mobile computing device. In some embodiments, the system and the method for accessing and using internal resources of a mobile device used in connection with and as a part of an industrial device includes a monitor program for use within an electronic and/or mechanical unit (hereinafter referred to as an “operating unit” or simply as a “unit”) of a productive environment.

In some embodiments, the system makes internal resources of a mobile device available outside the mobile device for one or more operating units of any of several industrial applications by using the mobile device's built-in communication hardware. In some embodiments, the method for accessing and using the internal resources of the mobile device is implemented as a monitor program that runs on the mobile device, thereby enabling access to the internal resources of the mobile device. The monitor program is an application that is central and fundamental to the operation of the system with respect to other device (or operating units). Also, the internal resources may vary from one mobile device to another mobile device. Examples of internal resources of the mobile device include, without limitation, an embedded/onboard camera of the mobile device, a keypad (which at a kernel layer receives alpha-numeric and symbolic inputs of a keyboard, whether a software-based keyboard displayed on a touchscreen or hardware-based keyboard), GPS, accelerometer, memory, display, etc. The mobile device may be a cell phone, such as a smartphone, a tablet computing device, a personal digital assistant (PDA), such as an iPod™ (by Apple Inc.), etc. Examples of communication hardware include, without limitation, Bluetooth, GSM, Wi-Fi, serial COM port, etc.

In some embodiments, the system is used (by a user) as a development tool to facilitate the use and the comprehension of the features provided through the system. In some embodiments, the system is deployed as a development tool by way of a circuit board (hereinafter also referred to as an “IOTKIT”). In some embodiments, the IOTKIT includes an interface to communicate via Bluetooth, another interface to communicate with a COM port, and a microprocessor to allow the user to develop test programs. In some embodiments, the combination of the mobile device and the IOTKIT form the development tool.

In some embodiments, the system is encapsulated into a device in an integration of an IOTKIT and its features directly into a mobile device or other type of computing device. In some embodiments, the integration is accomplished by way of a hybrid IoT device chip (hereinafter also referred to as an “IOT CHIP”) that can be mounted inside a circuit board like any other component.

In some embodiments, the operating unit is equipped with a control panel that accepts wireless and/or wired communication with a mobile computing device, such as a smartphone or a tablet computing device, and both the control panel and mobile computing device (e.g., smartphone, tablet, etc.) are equipped with various relevant and pre-existing computer applications (hereinafter referred to as “apps” or “mobile apps”). These apps enable the mobile device (e.g., smartphone, tablet, etc.) to receive and display data from the unit, and monitor, operate, and/or control the unit.

In some embodiments, the system for accessing and using internal resources of a mobile device used in connection with and as a part of an industrial device features an operating unit of a productive environment, a control panel component that operates the unit, and various pre-existing apps that are relevant to, and contained and used by, the unit. In some embodiments, apps for correspondence and communication (“correspondence and communication apps”) with those featured on the operating unit are included for download on and use by a mobile computing device. In some embodiments, the correspondence and communication apps are programmed to allow display and exchange of data between the mobile computing device and the operating unit. In this way, the system and the method for accessing and using internal resources of a mobile device used in connection with and as a part of an industrial device eliminates the need for the operating unit of the productive environment to be equipped with particular components, such as individual monitors and programs. This results in cost savings since the unit need not be equipped with any such components or programs. The use of the correspondence and communication apps with respect to various operating units provides a general solution for the control and operation of the units, thereby eliminating the costs and time of development of custom apps for each respective operating unit to which the system and the method for accessing and using internal resources of a mobile device used in connection with and as a part of an industrial device can be applied. These savings in costs and time are greatly extended in circumstances in which the correspondence and communication apps can be utilized across all relevant components of an IoT ecosystem, which may include several distinct operating units.

In some embodiments, the system and the method for accessing and using internal resources of a mobile device used in connection with and as a part of an industrial device includes a control panel of mechanical and/or electronic operating equipment in a production environment. In some embodiments, the control panel includes a central processing unit (CPU) and one or more pre-existing apps that pertain specifically or generally to the operating equipment in which the system and the method for accessing and using internal resources of a mobile device used in connection with and as a part of an industrial device is deployed and utilized.

In some embodiments, the control panel component features various methods of communication with the app-hosting communication device, such as but not limited to USB, Bluetooth™, and Wi-Fi™.

In some embodiments, an exterior facing surface of the control panel includes a USB port, used for connection to and communication with the mobile computing device of the system and the method for accessing and using internal resources of a mobile device used in connection with and as a part of an industrial device. The mobile computing device may be a smartphone or a tablet computing device, for example. In some embodiments, the mobile computing device also includes the pre-existing apps related to the particular operating equipment. In some embodiments, the control panel includes wireless transceiver equipment. Examples of transceiver equipment include, without limitation, Bluetooth™ electronic wireless communication modules and Wi-Fi™ electronic wireless communication modules.

As stated above, many industrial machines and devices include applications that operate aspects of the machines or monitor things outside of the machines, etc. However, many times a user would like to be able to control or evaluate operation of the industrial machines when not actually present in or around the area. This is a problem especially in contaminated areas or other areas in which knowledgeable human workers are not able to be present. Additionally, many aspiring engineers and developers would like to understand ways to interact with, monitor, or otherwise operate said industrial machines via such applications, but may lack sufficient knowledge to do so. Embodiments of the system and method for accessing and using internal resources of a mobile device used in connection with and as a part of an industrial device described in this specification solve such problems by providing a way to access all internal resources available from a mobile device (e.g., a smartphone), including memory, cameras, sensors, GPS, web access, Bluetooth, audio/video recorder, etc., by way of an internal software connected to the external world with Bluetooth, serial USB communication, etc.

Embodiments of the system and method for accessing and using internal resources of a mobile device used in connection with and as a part of an industrial device described in this specification differ from and improve upon currently existing options. In particular, some embodiments differ by using the hardware inside a smartphone that, thanks to the-billions units produced, cost a fraction of the one bought individually, and by leveraging the monitor program that saves one from having to create and code customized programs for each and every type of industrial device one may seek to interact with.

As a result, the system and method for accessing and using internal resources of a mobile device used in connection with and as a part of an industrial device drastically shortens development time while enabling ways to produce security, alarms, video/audio surveillance, etc., all through the internal computing and sensor-based components of a mobile device (a mobile device as ubiquitous as a smartphone is sufficient for these purposes).

By way of example, a soda bottling machine can include an externally-accessible control panel. With internal apps, the CPU within this control panel records: rate of production in number of units, inventory volumes of all bottles and separated soda ingredients, temperature of machine equipment, volume of lubrication used by machine equipment, record of technician services performed, and computer noted errors in production, such as spillage and spillage causes.

A technician of the facility using said soda bottling machine can have a smartphone with apps that correspond to those used by the machine. With wireless alignment and/or by direct cable connection or by connecting to the server, the technician can receive the data reported by the app. The technician can then perform any regular maintenance or repair of need. As such, an operator of the facility may use the system and the method for accessing and using internal resources of a mobile device used in connection with and as a part of an industrial device to determine need for specific materials. Similarly, a supervisor of the facility may use the system and the method for accessing and using internal resources of a mobile device used in connection with and as a part of an industrial device to determine rate of production and product loss ratio.

The system and method for accessing and using internal resources of a mobile device used in connection with and as a part of an industrial device of the present disclosure may be comprised of the following elements. This list of possible constituent elements is intended to be exemplary only and it is not intended that this list be used to limit the system and method for accessing and using internal resources of a mobile device used in connection with and as a part of an industrial device of the present application to just these elements. Persons having ordinary skill in the art relevant to the present disclosure may understand there to be equivalent elements that may be substituted within the present disclosure without changing the essential function or operation of the system and method for accessing and using internal resources of a mobile device used in connection with and as a part of an industrial device.
1. IOT KIT Development tool
2. Associated web server
3. A mobile device (such as a smartphone or tablet)
4. Monitor program/application (which runs on the mobile device)

The various elements of the system and method for accessing and using internal resources of a mobile device used in connection with and as a part of an industrial device of the present disclosure may be related in the following exemplary fashion. It is not intended to limit the scope or nature of the relationships between the various elements and the following examples are presented as illustrative examples only. In some embodiments, the IOT KIT (item #1) includes a printed circuit board (PCB) with Bluetooth with serial interface, a USB serial interface connected to the mobile device (item #3), a 433 MHz transceiver and a powerful microprocessor Arduino Mega compatible. The IOT KIT (item #1) allows the user to communicate with monitor program (item #4) running on the mobile device (item #3) in some way, such as to issue a command, to request some data, etc. The communication can be completed by the user in simple words (such as in common language words in a language of choice, e.g., English). For example, the user may communicate with the monitor program (item #4) running on the mobile device with words “pic front” which will result in the mobile device taking of a picture using the front camera of the mobile device, even though the user may not be holding the mobile device or even nearby the mobile device, but instead, is communicating from another device connected, via the IOT KIT (item #1), to the mobile device (item #3). A serial stream of the picture data is then output using USB, WiFi, or Bluetooth to the web server (item #2). The 433 MHz transceiver, given its long range (˜1 mile), can send activation commands and receive status to/from remote devices (e.g., causing the mobile device to take a picture even when at a distance, operating or checking the status of an electrified gate, etc.). In a different example, the user may communicate with the “gps” as the word, which will result in the mobile device calculating and outputting its geolocation based on data received from multiple GPS satellites (i.e., the mobile device will read the latitude and longitude coordinates). The web server (item #2) receives the data that is output upon receiving user's communication and stores the data in a database. For example, when the user communicates with “gps”, the mobile device (item #3) will calculate and output the geolocation (latitude and longitude) and the web server (item #2) will store the geolocation data in the database. In some embodiments, the web server (item #2) is interactive. That is, the web server can send commands to the operating unit controlled/monitored by the system for accessing and using internal resources of a mobile device described in this specification. Additionally, the server can produce documentation of the tasks for customers. For example, the server may generate and output a spreadsheet file (such as a Microsoft™ Excel™ file or a .CSV formatted file) with the documentation.

In some embodiments, the system and method for accessing and using internal resources of a mobile device used in connection with and as a part of an industrial device is used as a development tool. For example, a person, such as an electrical engineer who has a project to design, may evaluate whether the tools and functions provided by the system and method for accessing and using internal resources of a mobile device used in connection with and as a part of an industrial device allow for a convenient way to integrate certain features or functions in a particular design, then define the parts or functions necessary, and finally write the appropriate code to make it work.

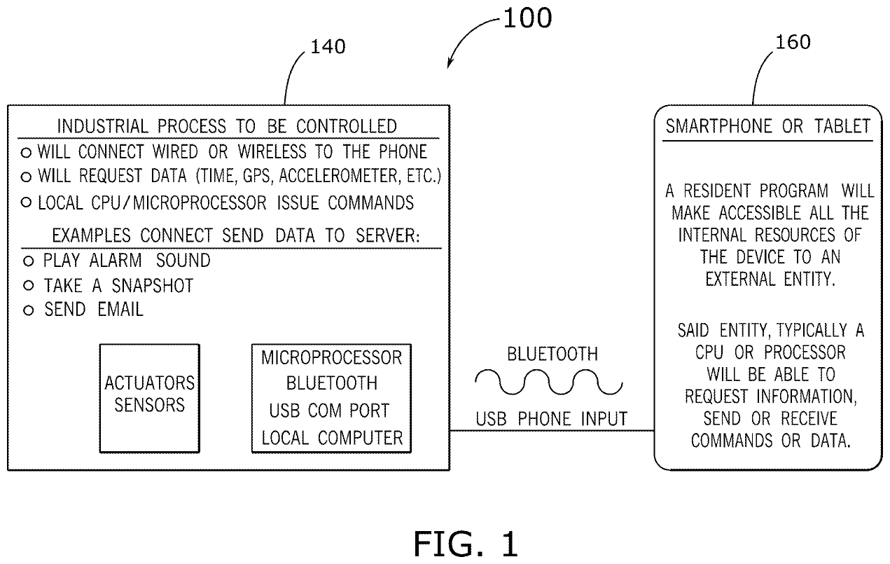

By way of example, FIG. 1 conceptually illustrates a block diagram of a system that accesses and uses internal resources of a smartphone in connection with an industrial device. As shown in this figure, the block diagram of the system depicts a high level, overall method 100 to access and use the internal resources of the smartphone in connection with the industrial device. Also shown in this figure is a generic industrial device 140 and a mobile device 160. As presented in this example, the mobile device 160 is either a smartphone or a tablet computing device. However, the mobile device 160 may alternatively be another type of mobile device, so long as the mobile device is capable of storing, executing (or launching), and running a resident program (i.e., the monitor program) that makes several internal resources of the mobile device 160 available externally, that is, outside of the mobile device 160, such as to an external processing unit or CPU of an external device. In this way, the external device or process may utilize the internal resources of the mobile device 160 to request information, send or receive commands, send or receive data, or otherwise communicate externally through the mobile device 160 to an industrial device, such as the generic industrial device 140 shown in this figure.

The generic industrial device 140 may be a machine or system in a productive environment and typically includes a CPU or microprocessor, Bluetooth, at least one USB COM port, and a local computer or access panel (control panel). The generic industrial device 140 also typically includes one or more actuators and/or sensors that allow for and carry out productive operations of an industrial process of the generic industrial device 140. The high level, overall method 100 to access and use the internal resources of the smartphone (mobile device 160) in connection with the generic industrial device 140 will allow for the industrial process of the generic industrial device 140 to be controlled when connected to the mobile device 160 either by wired connection or wireless connection via Bluetooth or the USB COM port (or both). The mobile device 160 is then able to request data from the generic industrial device 140, such as “time”, “GPS”, “accelerometer”, etc. The local CPU/microprocessor of the generic industrial device 140 issues the commands based on the requests from the mobile device 160. Examples of the commands that may be issued as part of the industrial process of the generic industrial device 140 include playing an alarm sound via the mobile device 160 audio speaker, taking a snapshot with the mobile device 160 camera, sending an email with relevant information, or a combination of commands such as detecting an alarm sound of the generic industrial device 140, taking a snapshot in response to the detected alarm sound, and sending an email with the snapshot picture attached to relevant personnel.

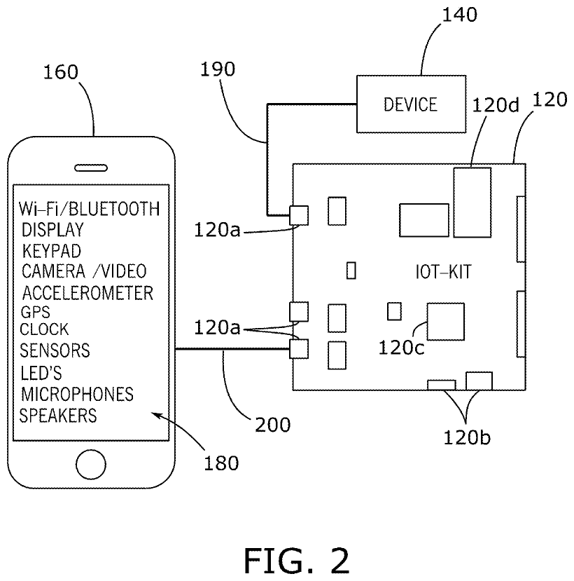

Turning to another example, FIG. 2 conceptually illustrates a schematic diagram of a system that accesses and uses internal resources of a smartphone in connection with an industrial device. As shown in this figure, the mobile device 160 and the generic industrial device 140 are connected by way of an IOTKIT 120. The IOTKIT 120 includes several elements, such as a plurality of USB ports 120a, a plurality of device inputs 120b, a microprocessor 120c, and a Bluetooth low energy (BLE) module 120d. The mobile device 160 includes a mobile app that runs as the monitor program on a microcontroller or a processor of the mobile device 160 and which provides access to a plurality of mobile device functions/apps 180. The plurality of mobile device functions/apps shown in this figure include WiFi/Bluetooth, display, keypad, camera/video, accelerometer, GPS, mobile device clock, sensors, LEDs, microphones, and audio speakers, but other functions/apps are available depending on the available hardware devices and modules present within or onboard the mobile device 160.

Operationally, a first connection 200 from the mobile device 160 to the IOTKIT 120 allows for (wired or wireless) transmission of command requests by the mobile device 160 to a USB port 120a of the IOTKIT 120 (which may be a USB COM port or a Bluetooth serial interface port), while a second connection 190 from another USB port 120a of the IOTKIT 120 (again, which may be a USB COM port or a Bluetooth serial interface port) to the generic industrial device 140 allows for (wired or wireless) transmission of these commands to the generic industrial device 140. Similarly, resulting data output is transmitted back to the IOTKIT 120 from the generic industrial device 140 over the second connection 190 and to the mobile device 160 from the IOTKIT 120 over the first connection 200, as well as to the web server for storage in the database and other processing or displaying of the data.

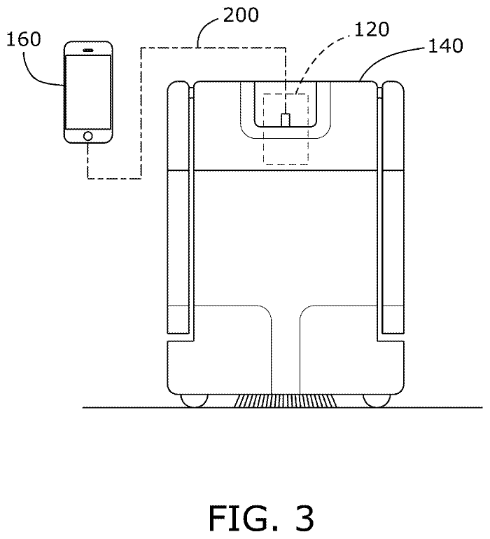

Now referring to FIG. 3, which conceptually illustrates an elevation view of the system, during use, while accessing and using internal resources of a smartphone in connection with an industrial device. As shown in this figure, the mobile device 160 connects to the IOTKIT 120 over the first connection 200 while the IOTKIT 120 connects to (or is integrated within) to the generic industrial device 140. In this example, the generic industrial device 140 appears to have some bristles or a brush protruding from a bottom side of device 140 and which are aligned down to a floor level. For purposes of illustration, these bristles or the brush may suggest that the generic industrial device 140 is a specific type of industrial cleaning device.

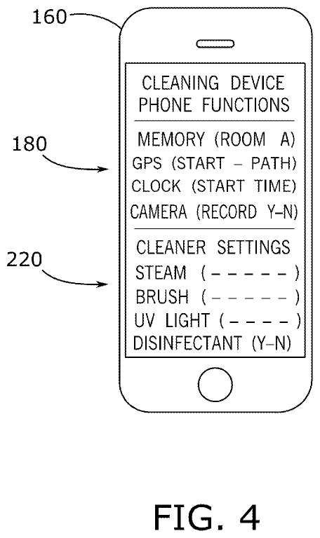

Now referring to FIG. 4, an example is demonstrated of a user interface of a cleaning device smartphone used for its internal resources in connection with an industrial cleaning device, such as that described above, by reference to FIG. 3. Specifically, the mobile device 160 in this example is a smartphone with a cleaning device application that corresponds to a pre-existing app of the industrial device 140 to which its internal functions are utilized to monitor and control. Thus, there are a plurality of mobile device functions/apps 180 that are accessible (such as memory, GPS, clock, camera, etc.) which allow access to the internal resources of the mobile device 160, and an application interface 220 to monitor/control the industrial device 140, with cleaner settings and functions related to “STEAM”, “BRUSH”, “UV LIGHT”, and “DISINFECTANT” (as a toggle option). Furthermore, there may be additional cleaner settings and functions corresponding to the pre-existing app of the industrial device 140 which are not shown in this figure.

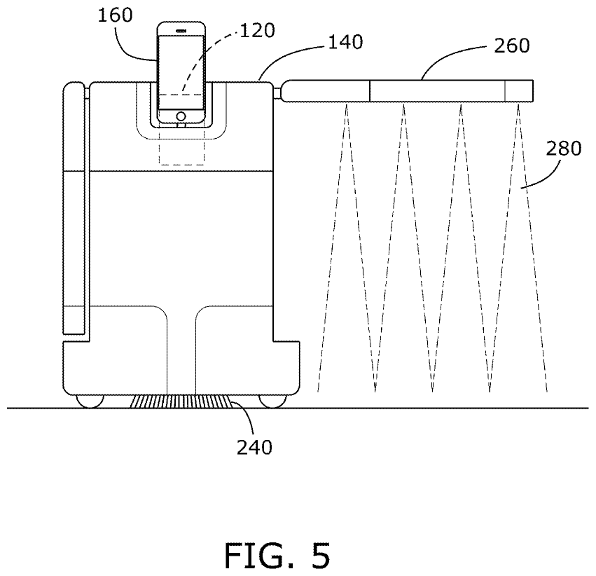

By way of another example, FIG. 5 conceptually illustrates an elevation view of the system controlling operation of an industrial device (specifically, an industrial cleaning device) by accessing and using the internal resources of a mobile device. As shown in this figure, the mobile device 160 is connected directly into an operating unit interface of the industrial cleaning device 140 with the IOTKIT 120 facilitating the interconnection between the mobile device 160 and the industrial cleaning device 140 at the operating unit interface point. Also shown in this figure, a brush 240 of the industrial cleaning device 140 is aligned below the operating unit to clean the floor, while a steam arm 260 is extended out from the industrial cleaning device 140 to emit steam 280 to the floor as the industrial cleaning device 140 moves over the floor and, for example, uses the brush 240 to scrub the steamed floor. While this example focuses on an industrial cleaning device, the generic industrial device 140 may alternatively be a disinfectant operating unit. One may imagine, based on this example, that instead of steam cleaning, the industrial device 140 includes an ultra-violet light emitting arm that extends out and uses UV light to kill germs and bacteria that may be present in the air or on the floor.

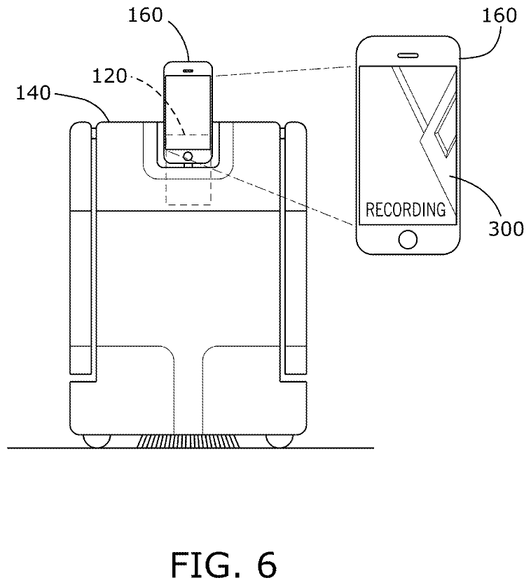

In yet another example, FIG. 6 conceptually illustrates an elevation view of the system recording a video with a connected smartphone during operation of an industrial device that is controlled by accessing and using the internal resources—specifically, the camera—of the mobile device 160. As shown in this figure, the mobile device 160 connects to the generic industrial device 140 at the operating unit interface by way of the IOTKIT 120 (either embedded and incorporated, or externally connected between the mobile device 160 and the industrial device 140). The camera of the mobile device 160 is utilized to capture a video recording 300 (or to capture one or more still images) of an area in need of cleaning or which has been cleaned (or for any other reason, such as intruder detection and evaluation, image/video capture in an area not suitable for human presence such as an area of high radiation or an area exposed to toxic chemicals or gasses, etc.).

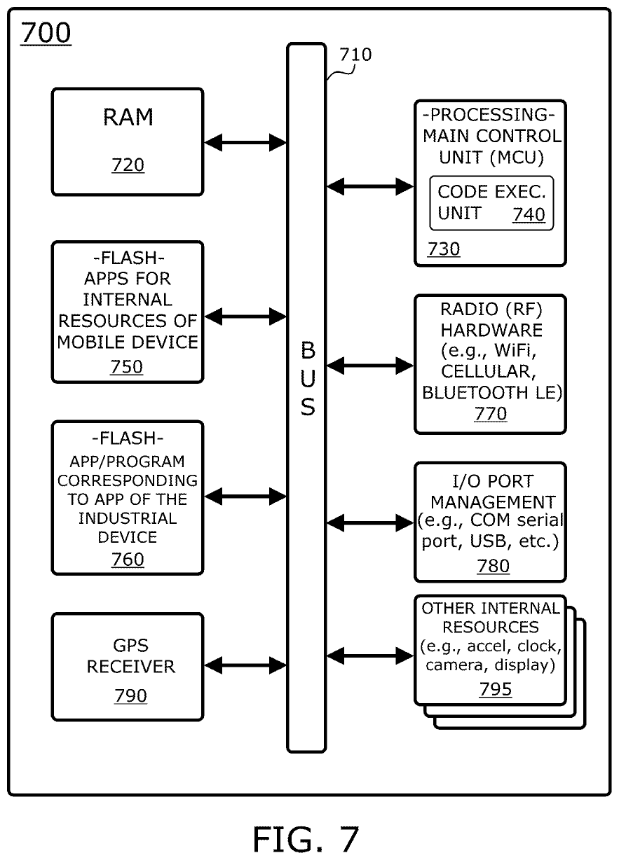

By way of example, FIG. 7 conceptually illustrates conceptually illustrates a block diagram of a mobile device 700 with internal resources used by the system. As shown in this figure, the mobile device 700 includes a bus 710, a random access memory (RAM) 720, a main control unit (MCU) 730 for runtime processing of the monitor program or other programs (or “mobile apps” or “apps”) running on the mobile device 700, a code execution unit 740 embedded within the MCU 730, a first persistent flash memory 750 that stores apps for the internal resources of the mobile device, a second persistent flash memory 760 that stores one or more apps/programs that correspond to pre-existing apps/programs of a target industrial device to be monitored/controlled, radio (RF) hardware 770 (such as WiFi, cellular, Bluetooth LE, etc.), an input/output (I/O) port management 780 unit (such as for COM serial port, USB port, etc.), a GPS receiver 790 as an exemplary internal resource of the mobile device 700, and other internal resources 795 of the mobile device (such as accelerometer, mobile device internal clock, onboard camera, display screen of mobile device, or any other internal resource of the many exemplary internal resources of the mobile device described in this specification). In some embodiments, the monitor program is stored on the first persistent flash memory 750. In some embodiments, the monitor program is stored on the second persistent flash memory 760. In some embodiments, the monitor program is stored on either or both of the first persistent flash memory 750 and the second persistent flash memory 760.

Many of the above-described features and applications are implemented as software (or “app”) processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the terms “software”, “mobile app”, “app”, and/or “program” are meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

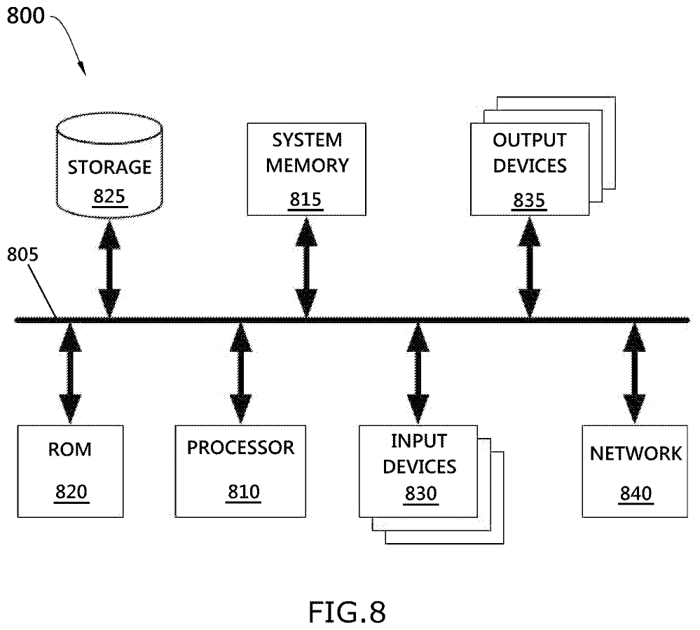

FIG. 8 conceptually illustrates an electronic system 800 with which some embodiments of the invention are implemented. The electronic system 800 may be a computer, phone (cellular, smartphone), tablet computing device, PDA, or any other sort of electronic device. The electronic system 800 can therefore be an underlying hardware structure of an IOTKIT circuit board device and other connected components, such as its processor, USB ports, and other connected devices or modules. Such an electronic system, whether as an IOTKIT or another device used in conjunction with the system, includes various types of computer readable media and interfaces for various other types of computer readable media. Electronic system 800 includes a bus 805, processing unit(s) 810, a system memory 815, a read-only memory 820, a permanent storage device 825, input devices 830, output devices 835, and a network adapter 840.

The bus 805 collectively represents all system, peripheral, and chipset buses that communicatively connect the numerous internal devices of the electronic system 800. For instance, the bus 805 communicatively connects the processing unit(s) 810 with the read-only memory 820, the system memory 815, and the permanent storage device 825.

From these various memory units, the processing unit(s) 810 retrieves instructions to execute and data to process in order to execute the processes of the invention. The processing unit(s) may be a single processor or a multi-core processor in different embodiments.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some embodiments of the invention use a mass-storage device (such as a magnetic or optical disk and its corresponding disk drive) as the permanent storage device 825.

Other embodiments use a removable storage device (such as a floppy disk or a flash drive) as the permanent storage device 825. Like the permanent storage device 825, the system memory 815 is a read-and-write memory device. However, unlike storage device 825, the system memory 815 is a volatile read-and-write memory, such as a random access memory (or “RAM 815”). The system memory 815 stores some of the instructions and data that the processor needs at runtime. In some embodiments, the invention's processes are stored in the system memory 815, the permanent storage device 825, and/or the read-only memory 820. For example, the various memory units include instructions for processing appearance alterations of displayable characters in accordance with some embodiments. From these various memory units, the processing unit(s) 810 retrieves instructions to execute and data to process in order to execute the processes of some embodiments.

The bus 805 also connects to the input and output devices 830 and 835. The input devices enable the user to communicate information and select commands to the electronic system. The input devices 830 include alphanumeric keyboards and pointing devices (also called “cursor control devices”). The output devices 835 display images generated by the electronic system 800. The output devices 835 include printers and display devices, such as liquid crystal displays (LCD) or organic light emitting diode (OLED) displays. Some embodiments include devices such as a touchscreen that functions as both input and output devices.

Finally, as shown in FIG. 8, bus 805 also couples electronic system 800 to a network through a network adapter 840, that may be a wired network adapter (such as an Ethernet adapter) or a wireless communication module (such as WiFi). In this manner, the computer can be a part of a network of computers (such as a local area network (“LAN”), a wide area network (“WAN”), or an intranet), or a network of networks (such as the Internet). Any or all components of electronic system 800 may be used in conjunction with the invention.

These functions described above can be implemented in digital electronic circuitry, computer software, firmware or hardware. They can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A system to access and use the internal resources of a mobile device used in connection with and as a part of an industrial device, the system comprising:
a mobile device comprising a mobile processor, a USB data interface, and a plurality of internal resources;
an IOTKIT comprising a printed circuit board (PCB) with a Bluetooth serial interface, a USB serial interface that connects to the USB data interface of the mobile device, a 433 MHz transceiver, and a microprocessor;
an industrial device that operates in a productive environment, said industrial device comprising a pre-existing app, an access panel, and an operating unit interface to which the IOTKIT is connected, wherein the IOTKIT enables a connection between the industrial device and the mobile device;
a monitor program that is installed on the mobile device and runs on the mobile processor during execution to provide access to the plurality of internal resource of the mobile device and a user interface corresponding to a pre-existing app of the industrial device, wherein the IOTKIT allows a user to communicate with the monitor program to send commands and request data, wherein the monitor program transmits user commands and requests for data to the industrial device when the monitor program receives said user commands and requests for data via the IOTKIT; and
a web server that receives a serial stream of data output in response to the commands and requests for data transmitted from the monitor program to the industrial device.

2. The system of claim 1, wherein the plurality of internal resources of the mobile device comprises at least one of an onboard camera, a keypad, a GPS receiver, an accelerometer, an internal mobile device clock, an audio speaker, a microphone, a memory module, a display, and communication hardware.

3. The system of claim 2, wherein the communication hardware comprises one of Bluetooth, GSM, Wi-Fi, and a serial COM port.

4. The system of claim 1, wherein a combination of the mobile device, the monitor program, and the IOTKIT form a development tool that is utilized by a developer to develop test programs for simulated industrial applications.

5. The system of claim 4, wherein the Bluetooth serial interface allows the developer to communicate via Bluetooth, the USB serial interface allows the developer to communicate via a COM port, and the microprocessor allows the developer to run the test programs for simulated industrial applications.

6. The system of claim 1, wherein the IOTKIT is integrated into the mobile device as a hybrid Internet-of-Things (“IOT”) chip that is mounted as a component of the industrial device.
